(19) United States
(12) Patent Application Publication
(10) Pub. No.: US 2007/0077374 A1
(43) Pub. Date: Apr. 5, 2007

(54) TWO-SHOT DECORATIVE TRIM PANEL

(75) Inventors: Glenn A. Cowelchuk, Chesterfield Township, MI (US); David J. Dooley, Troy, MI (US); Todd L. DePue, Brighton, MI (US); Randy S. Reed, Fair Haven, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,109

(22) Filed: Oct. 5, 2005

(51) Int. Cl. B29C 45/00; B60R 13/00

(52) U.S. Cl. 428/31; 264/255; 264/328.8

(57) ABSTRACT

In at least certain embodiments, the present invention relates to automobile interior trim panel having an insert molded trim cover sheet. In at least one embodiment, the automobile interior trim panel is made by providing a trim cover sheet within a first mold cavity and introducing a first resin into the first mold cavity to form a door panel sub assembly comprising a door panel portion secured to the trim cover sheet. In this embodiment, the door panel portion has a first upper door panel portion having a portion circumscribing the trim cover sheet and a lower door panel portion below the first upper door panel portion. The method further comprises providing the door panel sub assembly within a second mold cavity, and introducing a second resin less rigid that the first material into the second mold cavity to form a second upper door panel portion over and secured to at least a portion of the first upper door panel portion.

### BACKGROUND OF THE INVENTION

1. Field of the Invention

The present invention is related to a two-shot decorative trim panel.

2. Background Art

Motor vehicle interiors have many interior components made of trim panels. One of the more relatively common types of interior components is an interior door panel.

Some of the more common interior door panels comprise a rigid door panel substrate and a relatively soft bolster. In these types of door panels the bolster is typically disposed above an armrest of the door panel and below an upper edge of a door. While the bolster typically provides a decorative and/or soft area to a portion of the door panel above the armrest, the remainder of the door panel above the arm rest remains relatively rigid, especially in contrast to the bolster area. Such a contrast can be aesthetically and functionally (such as tactilely) displeasing to some discerning customers.

Moreover, in a typical door panel manufacturing process, the bolster, the rigid upper door panel, and the rigid lower door panel substrate are formed separately and heat staked or attached via other suitable attachment mechanisms to form a door panel. Such a manufacturing process requires a secondary operation such as heat staking. Also, due to the inherent give between the heat staked bolster and the door substrate, rattling and squeaking can occur during operation of the vehicle.

Accordingly, it would be desireable to provide a trim panel having a decorative trim portion, such as a door bolster, which would overcome at least one of the deficiencies in the prior art.

### SUMMARY OF THE INVENTION

According to one aspect of the present invention, a method of making an automobile interior trim panel is provided. In at least one embodiment, the method comprises a) providing a molding tool comprising a first mold half and a second mold half, with the first and second mold halves cooperating to form a first mold cavity. In this embodiment, the method further comprises b) providing a trim sheet within the first mold cavity, with the first mold half, the second mold half, and the trim sheet cooperating to form a second mold cavity, and c) introducing a first resin into the second mold cavity to form a door panel sub assembly comprising a door panel portion secured to the trim sheet, with the door panel portion having a first upper door panel portion circumscribing the trim sheet and a lower door panel portion below the first upper door panel portion. In this embodiment, the method further comprises d) providing the door panel sub assembly within the first mold half and a third mold half, with the first mold half, the third mold half, and the door panel sub assembly forming a third mold cavity, and e) introducing a second resin less rigid that the first material into the third mold cavity to form a second upper door panel portion over and secured to at least a portion of the first upper door panel portion.

In at least one embodiment of the present invention, the second upper door panel portion is disposed over and secured to a substantial portion of the first upper door panel portion and circumscribes the trim cover sheet.

In at least one embodiment of the present invention, the trim cover sheet comprises a decorative fabric, a grained polymeric sheet material, a composite of multiple materials such as thermoplastics, thermosets, fabric, scrim and natural fiber, and combinations thereof. In at least another embodiment of the present invention, the trim cover sheet further comprises a foam backing layer disposed on an underside of the sheet material. In at least yet another embodiment of the present invention, the first upper door panel portion includes a raised portion relative to an adjacent portion, the trim cover sheet covering and being secured to the raised portion. In still at least yet another embodiment of the present invention, the trim cover sheet and the raised portion cooperate to form a bolster portion of the trim panel.

In at least one embodiment of the present invention, the first resin comprises a thermoplastic resin. In at least another embodiment of the present invention, the first resin is selected from the group consisting of thermoplastic polyurethanes, thermoplastic olefins, polyvinyl chloride, polypropylene, and combinations thereof. In at least yet another embodiment of the present invention, the first resin is selected from the group consisting of homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the first resin is injected into the mold cavity at a temperature from 350° F. to 440° F. and a pressure from about 200 psi to about 2100 psi.

In at least one embodiment of the present invention, the second resin comprises a thermoplastic resin. In at least another embodiment of the present invention, the second resin is selected from the group consisting of homopolymers and copolymers of polyethylene, homopolymers and copolymers of polypropylene, filled polypropylene, thermoplastic olefins, thermoplastic urethanes, polycarbonate, acrylonitrile butadiene styrene, mixed acrylonitrile butadiene styrene and polycarbonate, and combinations thereof. In yet another embodiment of the present invention, the second resin comprises an elastomer. In still yet another embodiment of the present invention, the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

In at one embodiment of the present invention, the second resin is injected into the mold cavity at a temperature from about 350° F. to about 440° F. and a pressure from about 200 psi to about 2100 psi.

According to yet another aspect of the present invention, an automobile door panel is provided. In at least one embodiment, the automobile door panel is made in accordance with the method described above.

In yet another embodiment, the method of making an interior trim panel comprises a) positioning a trim cover sheet within a first mold cavity of a molding tool, with the first mold cavity and the trim cover sheet forming a second mold cavity, and b) introducing a first resin into the second mold cavity to form a door panel sub assembly comprising a door panel portion secured to the trim cover sheet, with the door panel portion having a first upper door panel portion generally circumscribing the trim cover sheet and a lower door panel portion generally below the first upper door panel portion. In this embodiment, the method further comprises c) positioning the door panel sub assembly within a third mold cavity, with the third mold cavity and the door panel sub assembly forming a fourth mold cavity, and d) introducing a second resin less rigid that the first resin into the fourth mold cavity to form a second upper door panel portion over and secured to at least a portion of the first upper door panel portion to form an automotive interior trim panel.

In still yet another embodiment of the present invention, the method of making an interior trim panel comprises providing a trim cover sheet within a first mold cavity and introducing a first resin into the first mold cavity to form a door panel sub assembly comprising a door panel portion secured to the trim cover sheet. In this embodiment, the door panel portion has a first upper door panel portion having a portion circumscribing the trim cover sheet and a lower door panel portion below the first upper door panel portion. The method further comprises providing the door panel sub assembly within a second mold cavity, and introducing a second resin less rigid that the first material into the second mold cavity to form a second upper door panel portion over and secured to at least a portion of the first upper door panel portion.

In yet another embodiment of the present invention, an automobile interior trim panel is provided comprising a trim panel portion made of a first rigid resin having a first upper door panel portion and a lower door panel portion generally below and integrally connected to the first upper door panel portion. In this embodiment, the first upper door panel portion has a target area. In this embodiment, the panel further comprises a trim cover sheet moldably secured to the target area, and a second upper door panel portion disposed over and secured to at least a portion of the first upper door panel portion, with the second upper door panel portion being made of a second resin less rigid than the first resin and covering at least a portion of the trim cover sheet.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is an idealized side view of an automobile interior panel made in accordance with an embodiment of the present invention;

FIG. 2 is a fragmentary sectional view of the automobile interior panel shown in FIG. 1, taken through line 2-2;

FIG. 3 is an illustration of a mold cooperating with a panel component to form a mold cavity;

FIG. 4 is a view similar to FIG. 3 showing the introduction of resin into the mold cavity;

FIG. 5 is a view similar to FIG. 4 showing a subassembly;

FIG. 6 is an illustration of a mold cooperating with the subassembly to form a mold cavity;

FIG. 7 is a view similar to FIG. 6 showing the introduction of resin into the cavity; and

FIG. 8 is a view similar to FIG. 1 showing an automobile interior panel made in accordance with another embodiment of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable preferred for a given purpose in connection with the invention implies that mixtures of any two or more members of the group or class may be equally suitable or preferred.

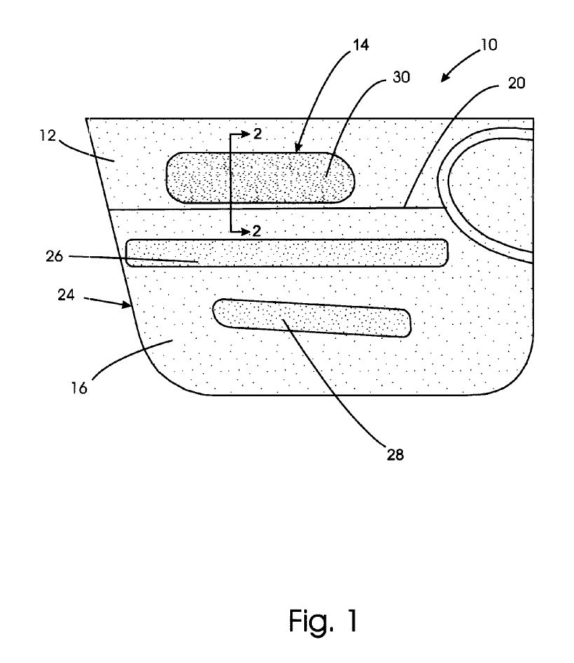

FIG. 1 shows an interior door panel 10 in accordance with at least one embodiment of the present invention. Certain aspects of the present invention will be described below in connection with the door panel 10. However, it should be understood that other trim products, such as instrument panels, glove box door covers, console sides, console covers, pillar trim panels, shelves, trim covers and the like may also enjoy the benefits of the present invention.

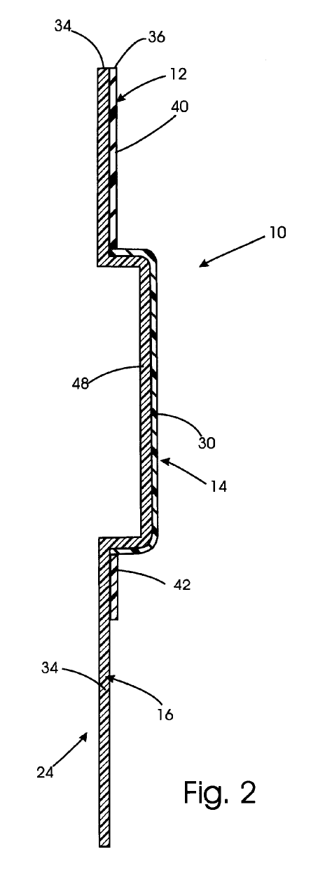

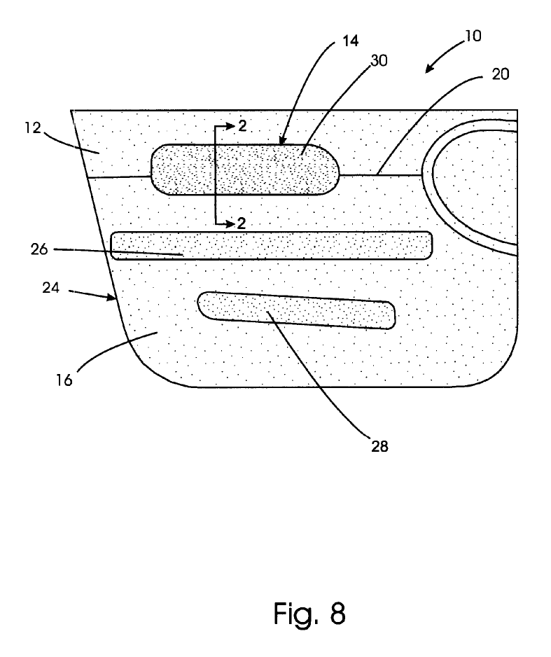

Referring to FIGS. 1 and 2, door panel 10 includes an upper door panel portion 12 having a bolster 14 and a lower door panel portion 16 generally below the upper door panel portion 12. While the primary line of demarcation 20 between the lower door panel portion 16 and the upper door panel portion 12 is shown in FIG. 1 to be roughly just below the bolster 14, the door panel 10 could alternatively be configured such that the line of demarcation 20 between portions 12 and 16 can be at any desired location, such as roughly at the midpoint of the bolster 14, as is shown in FIG. 8.

The door panel 10 includes a major panel 24 which may also include additional structures attached thereto. Referring again to FIG. 1, the door panel 10 can also include additional components such as an armrest 26 and a map pocket 28. In at least the embodiment illustrated in FIG. 1, the armrest 26 is secured to the major panel 24 and the map pocket 28 is formed in the major panel.

The bolster 14 includes a trim cover layer 30. The trim cover layer 30 can be any suitable sheet material for providing a decorative and/or relative soft area to the door panel 10.

With reference to FIG. 2, the upper door panel portion 12 includes a first relatively rigid upper panel portion 34 and a second less rigid upper panel portion 36. The first upper panel portion 34 is integral with and made of the same relatively rigid material as the lower panel portion 16. The first upper panel portion 34 and the lower panel portion 16 together form the major door panel 24.

In the illustrated embodiment, the first upper panel portion 34 is roughly the same thickness of the lower panel portion 16, however these relative thicknesses can vary as desired. For instance, the first upper panel portion 34 can have a lesser or a greater thickness than the lower portion 16.

The second upper panel portion 36 is made of a less rigid material than the first upper panel portion 34. The second upper panel portion 36 is disposed over, and in at least one embodiment, covers the first upper panel portion 34. This is to provide a soft feel and/or a contrasting color to the upper door panel portion 12 relative to the lower door panel portion 16. In the embodiment illustrated in FIG. 1, the second upper panel portion 36 circumscribes the bolster 14, having opposed portions 40 and 42 on opposite sides of the bolster 14. While the second upper panel portion 36 is shown to entirely cover the entire upper surface, except for the bolster 14, of the first upper portion 34, it should be understood that the second upper panel portion could cover less than the entire upper surface of the first upper panel portion. For instance, the second upper panel portion 36 could cover only a portion, be it a substantial portion, roughly one-half, or a minor portion, of the upper surface of the first upper panel portion 34. Furthermore, it should be understood that the second upper panel portion 36 could cover more than the first upper panel portion 34.

In at least one embodiment, the lower panel portion 16 has a thickness of 1-5 mm, and in other embodiments of 2.5-3.5 mm. In at least one embodiment, the first upper panel portion 34 has a thickness of 1-5 mm, and in other embodiments of 2.5-3.5 mm.

In at least one embodiment, the second upper panel portion 36 has a thickness of 0.5-3 mm, and in other embodiments of 1-1.5 mm. In at least one embodiment, the combined thickness of the first and second upper panel portions 34 and 36 is greater than the thickness of the lower panel portion 16, however these relative thickness can vary as desired. For instance, the combined thickness of portions 34 and 36 could be roughly the same as, or even less than, the thickness of the lower panel portion 16.

The first upper panel portion 34 includes a target area 48, generally denoted in the location of the bolster 14, for receipt of the bolster trim cover layer 30. The trim cover layer 30 provides a decorative and/or relatively soft area to the door 10, i.e., helps to form the bolster 14. In at least the illustrated embodiment, the target area 48 is in a plane that is spaced from, such as above, the plane that the lower door panel portion 16 and a substantial portion of the first upper door panel portion 34 substantially extend in. The trim cover layer 30 is shown in the illustrated embodiments to cover less than the entire upper surface of first upper door portion 34. As will be explained further below, the trim cover layer 30 is secured to the target area 48 via molding of the target area 48 to the trim cover layer 30.

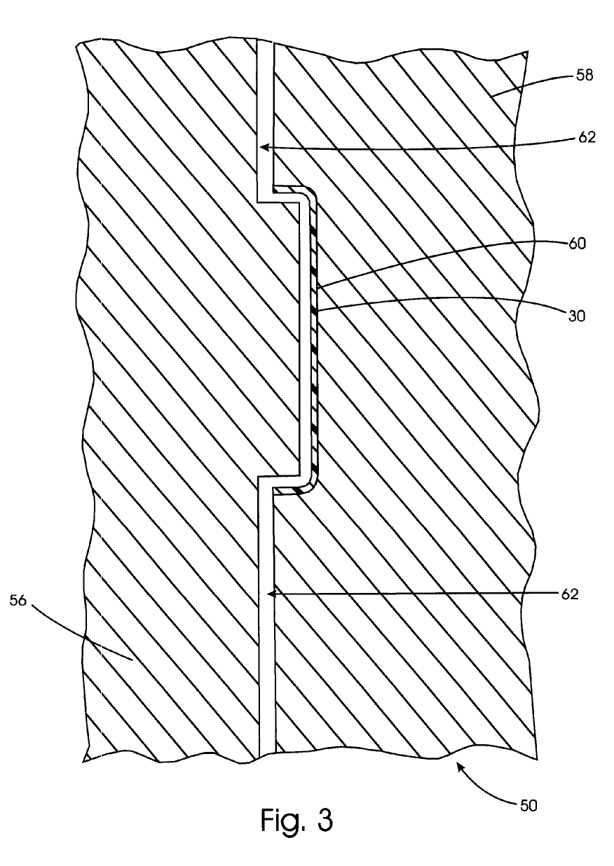

Referring to FIG. 3, a method of making a door panel 10 in accordance with the present invention will be described. FIG. 3 illustrates a mold tool 50 having core half 56 and a first cavity half 58. In at least the illustrated embodiment, the cavity half 58 has a surface 60 for receipt of the trim cover layer 30. The trim cover layer 30 may be held on surface 60 by any suitable means such as pins (not shown). The mold tool 50 may also, or alternatively, include moveable lifters (not shown) to help hold the trim cover layer 30 in place during molding of the major panel 24. In other embodiments, a vacuum or other holding means could be used in place of or in addition to the lifters and/or pins. As shown in FIG. 3, when mold tool 50 is closed (i.e. core half 56 and cavity half 58 are brought together to contact the trim cover layer 30, a cavity 62 is formed within the mold tool 50. It should be understood that the surface 60 for receipt of the trim cover layer 30 could alternatively be on the core half 56.

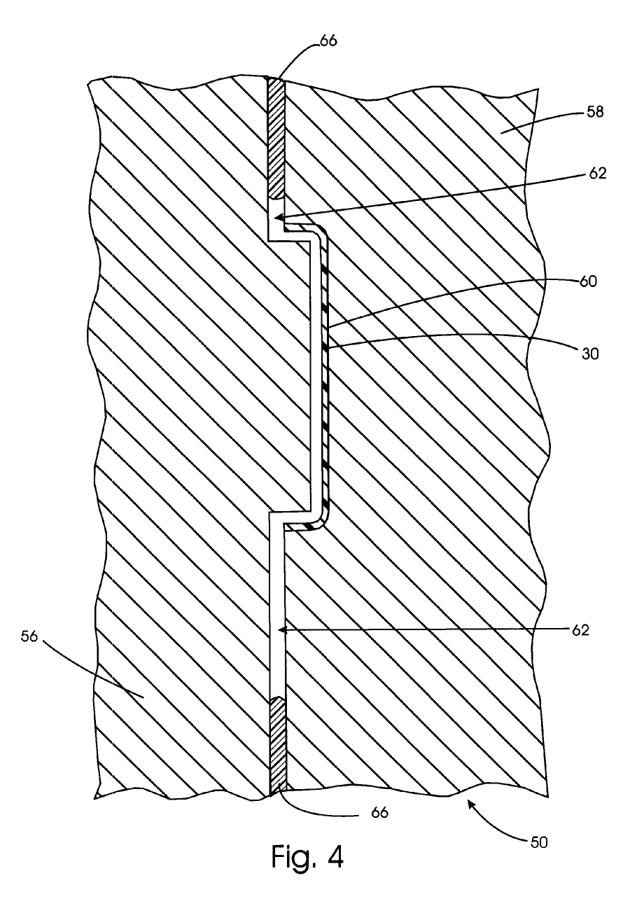

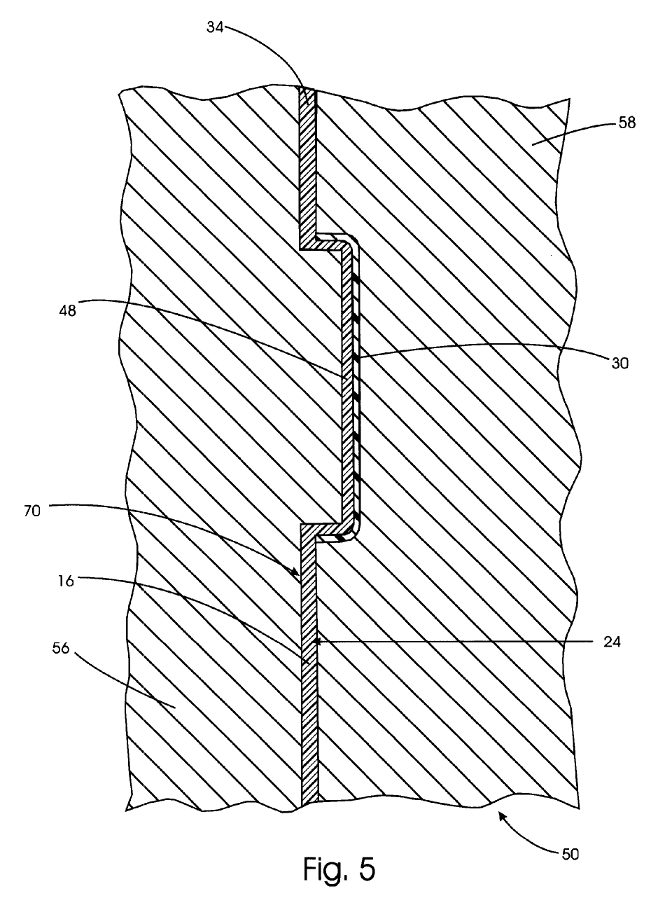

Next, referring to FIG. 4, resin 66 is introduced into the mold cavity 62. Typically, the resin 60 is injected into the mold cavity 62 at a temperature from about 350° F. to about 440° F. and a pressure from about 200 psi to about 2100 psi. It should be appreciated that these temperature and pressure ranges will vary depending on the materials used, however must be low enough not to substantially displace trim cover layer 30 during this molding step. The resin 66 flows through the mold cavity 62 filling the mold cavity 62, as can be understood from FIG. 5. The resin 66 upon cooling, or curing, forms major panel 24, as best shown in FIG. 2. In at least one embodiment, the resin 66 that cools to form the target area 48 bonds to trim cover layer 30.

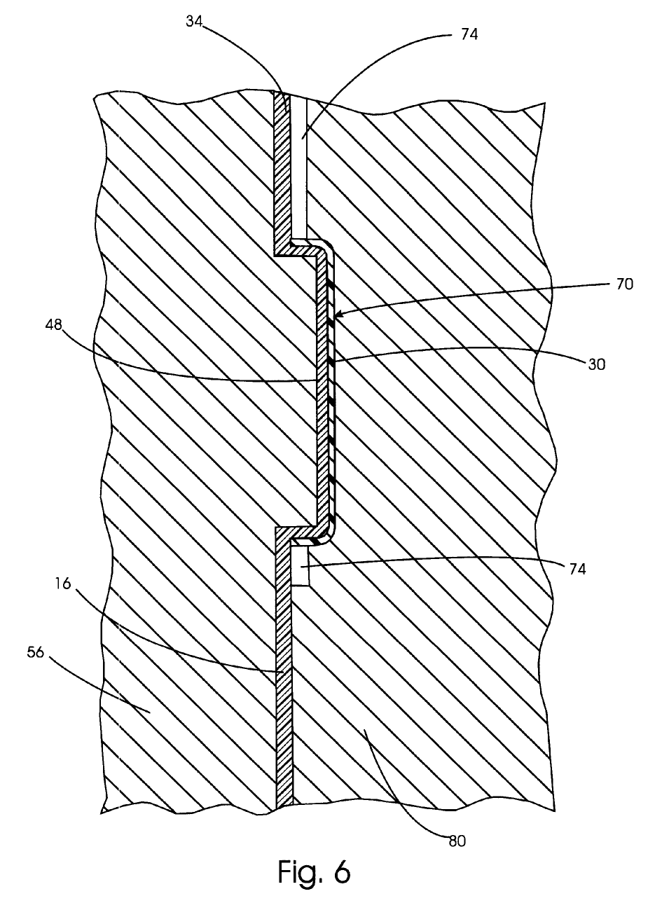

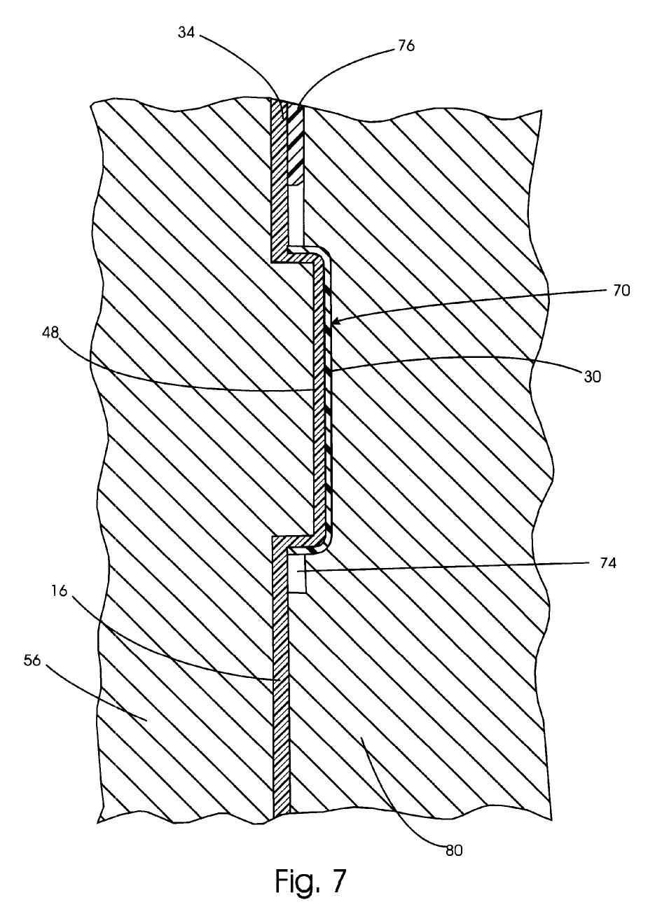

The major panel 24 and trim cover layer 30 form a door panel subassembly 70. As shown in FIG. 6, the door panel subassembly 70 is positioned within a mold forming a second mold cavity 74. The second mold cavity 74 is generally positioned above the first upper door portion 34 of the major panel 24 A second resin 76, referring to FIG. 7, is introduced into the mold cavity 74. Typically, the second resin 76 is injected into second mold cavity 74 at a temperature from about 350° F. to about 440° F. and a pressure from about 200 psi to about 2100 psi. It should be appreciated that these temperature and pressure ranges will vary depending on the materials used. It should be appreciated that the core half 56 and cavity half 58 (illustrated in FIGS. 3-5) may include moveable sections that are individually positionable to form the second mold cavity 74. Alternatively, as is shown in FIGS. 6 and 7, cavity half 58 may be replaced with a substitute cavity half 80 specifically designed to form the second mold cavity 74. The second resin 76, upon cooling, or curing, forms the second upper door portion 36 secured to and above the first upper door portion 34.

In at least one embodiment, the major panel 24 can be made of any suitable resin 66 such as a relatively hard, relatively rigid resin. Typically, useful resins 66 for the major panel 24 are thermoplastic resins. Particularly useful resins 66 for the major panel 24 include, for example, thermoplastic polyurethanes, thermoplastic olefins, polyvinyl chloride, polypropylene, and combinations thereof. More specific examples of useful resins 66 for the major panel 24 include homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

The trim cover layer 30 can be made of any suitable relatively non-rigid relatively soft skin layer material such as TPE, TEE, EPDM, any other suitable elastomeric materials, or a fabric material such as cloth, vinyl, or leather. In some embodiments, the trim cover 30 can comprise a decorative fabric, a grained polymeric sheet material, a composite of multiple materials such as thermoplastics, thermosets, fabric, scrim and natural fiber, and combinations thereof. In some instances, the trim cover layer 30 will comprise a layer of foam (polyurethane, polypropylene, polyethylene, etc.) between the skin layer and the target area 48.

The major panel 24 and the second upper panel portion 36 are made of different materials to provide a different appearance and/or feel between the lower door panel portion 16 and the upper door panel portion 12. The second upper panel portion 36 can be made of any suitable resin 76. Typically useful resins 76 for the second upper panel portion 36 are thermoplastic resins. Useful resins 76 for the second upper panel portion 36 include, for example, thermoplastic polyurethanes, thermoplastic olefins, polyvinyl chloride, polypropylene, and combinations thereof. More specific examples of useful resins 76 for the second upper panel portion 36 include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Since the second upper door panel portion 36 is usually softer than the remainder of the door panel portions 16 and 34 the resin 76 for the second upper panel portion 36 may also comprise one or more elastomers. Examples of useful elastomers for the second upper panel portion 36 include thermoplastic elastomers, styrene-ethylene-butylene-styrene elastomers, blocked copolymer thermoplastic elastomers, polyolefin-based elastomers, foamed thermoplastic elastomers, and combinations thereof. Also, the second resin 76 could result in a different color than the first resin 66. In at least one embodiment, the first resin 66 comprises TPO and the second resin 76 comprises TPE.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an automobile interior trim panel, said method comprising:
a) providing a molding tool comprising a first mold half and a second mold half, the first and second mold halves cooperating to form a first mold cavity;
b) providing a trim cover sheet within the first mold cavity, the first mold half, the second mold half, and the trim cover sheet cooperating to form a second mold cavity;
c) introducing a first resin into the second mold cavity, the resin, upon cooling, forming a door panel sub assembly, the door panel sub assembly comprising a door panel portion secured to the trim cover sheet, the door panel portion having a first upper door panel portion circumscribing the trim cover sheet and a lower door panel portion below the first upper door panel portion;
d) providing the door panel sub assembly within the first mold half and a third mold half, the first mold half, the third mold half, and the door panel sub assembly forming a third mold cavity; and
e) introducing a second resin less rigid that the first material into the third mold cavity, the second resin, upon cooling, forming a second upper door panel portion over and secured to at least a portion of the first upper door panel portion.

2. The method of claim 1 wherein the second upper door panel portion is disposed over and secured to a substantial portion of the first upper door panel portion and circumscribes the trim cover sheet.

3. The method of claim 1 wherein the first resin comprises a thermoplastic resin.

4. The method of claim 3 wherein the first resin is injected into the second mold cavity at a temperature from 350° F. to 440° F. and a pressure from about 200 psi to about 2100 psi.

5. The method of claim 3 wherein the first resin is selected from the group consisting of homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

6. The method of claim 1 wherein the trim cover sheet comprises, a decorative fabric, a grained polymeric sheet material, a composite of multiple materials such as thermoplastics, thermosets, fabric, scrim and natural fiber, and combinations thereof.

7. The method of claim 6 wherein the trim cover sheet further comprises a foam backing layer disposed on an underside of the sheet material.

8. The method of claim 6 wherein the first upper door panel portion includes a raised portion relative to an adjacent portion, the trim cover sheet covering and being secured to the raised portion.

9. The method of claim 8 wherein the trim cover sheet and the raised portion cooperate to form a bolster portion of the trim panel.

10. The method of claim 1 wherein the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

11. An automobile door panel made by the method of claim 1.

12. A method of making an automobile interior trim panel, said method comprising:
a) positioning a trim cover sheet within a first mold cavity of a molding tool, the first mold cavity and the trim cover sheet forming a second mold cavity;
b) introducing a first resin into the second mold cavity to form a door panel sub assembly, the door panel sub assembly comprising a door panel portion secured to the trim cover sheet, the door panel portion having a first upper door panel portion generally circumscribing the trim cover sheet and a lower door panel portion generally below the first upper door panel portion;
c) positioning the door panel sub assembly within a third mold cavity, the third mold cavity and the door panel sub assembly forming a fourth mold cavity; and
d) introducing a second resin less rigid that the first resin into the fourth mold cavity to form a second upper door panel portion over and secured to at least a portion of the first upper door panel portion to form an automotive interior trim panel.

13. The method of claim 12 wherein the second upper door panel portion is disposed over and secured to a substantial portion of the first upper door panel portion and circumscribes the trim cover sheet.

14. The method of claim 13 wherein the third mold cavity comprises the cooperation of the first mold half and a third mold half.

15. The method of claim 12 wherein the trim cover sheet comprises a relatively soft skin layer material.

16. The method of claim 15 wherein the trim cover sheet further comprises a foam backing layer disposed on an underside of the sheet material.

17. The method of claim 15 wherein the first upper door panel portion includes a raised portion relative to an adjacent portion, the trim cover sheet covering and being secured to the raised portion.

18. The method of claim 17 wherein the trim cover sheet and the raised portion cooperate to form a bolster portion of the trim panel.

19. An automobile door panel made by the method of claim 17.

20. An automobile interior trim panel comprising:
a trim panel portion made of a first rigid resin, the trim panel portion having a first upper door panel portion and a lower door panel portion generally below and integrally connected to the first upper door panel portion, the first upper door panel portion having a target area;
a trim cover sheet moldably secured to the target area; and
a second upper door panel portion disposed over and secured to at least a portion of the first upper door panel portion, the second upper door panel portion being made of a second resin less rigid than the first resin and covering at least a portion of the trim cover sheet.
